(19) United States
(12) Patent Application Publication
(10) Pub. No.: US 2009/0148157 A1
(43) Pub. Date: Jun. 11, 2009

(54) IDENTIFYING COMMUNICATION ERRORS CAUSED BY THE EXCHANGE OF UNSUPPORTED MESSAGES AMONG DEVICES IN A NETWORK

(75) Inventors: MARC R. BERNARD, Miramar, FL (US); JOHN T. BURCH, McLean, VA (US); DARREN J. DOWKER, Reston, VA (US); DAVID H. LIU, Herndon, VA (US); JOSEPH D. KRALOWETZ, Clarksville, MD (US)

Correspondence Address: FITZPATRICK CELLA (TELLABS), 30 ROCKEFELLER PLAZA, NEW YORK, NY, 10112-3800, US

(73) Assignee: TELLABS VIENNA, INC., Naperville, IL (US)

(21) Appl. No.: 11/953,838

(22) Filed: Dec. 10, 2007

(51) Int. Cl. H04B 17/00

(52) U.S. Cl. 398/25

(57) ABSTRACT

A method, and an apparatus, system, and sequences of instructions that operate in accordance with the method, for identifying errors in communications in a system that provides services. In the method, control messages are generated and sent to a network device. Error information generated in response to an unsupported control message being received by the network device, from at least one controlling device, is stored in the network device. The error information stored in the network device is retrieved, and errors in communications between the network device and the controlling device are identified, based on the error information retrieved.

### BACKGROUND

1. Field

Example aspects of the invention generally relate to identifying and troubleshooting errors in a network, and, more particularly, to using information stored on devices in the network to identify communication errors caused by the exchange of unsupported messages among devices in the network.

2. Related Art

There is a growing demand in the industry to find a solution to transmit voice, data, or video from a headend to a subscriber's premises through a fiber optic network all the way into an individual home or business. Such fiber optic networks generally are referred to as fiber-to-the-home (FTTH), fiber-to-the-premises (FTTP), fiber-to-the-business (FTTB), fiber-to-the-node (FTTN), or fiber-to-the-curb (FTTC) networks and the like, depending on the specific application of interest. Such types of networks are also referred to herein generally as “FTTx networks”.

In a FTTx network, equipment at a headend or central office couples the FTTx to external services such as a Public Switched Telephone Network (PSTN) or an external network. Signals received from these services are converted into optical signals and are transmitted using a single optical fiber at a plurality of wavelengths, with each wavelength defining a channel within the FTTx network.

In a FTTP network, the optical signals are transmitted through the FTTP network to an optical splitter that splits the optical signals and transmits each individual optical signal over a single optical fiber to a subscriber's premises. At the subscriber's premises, the optical signal is converted into at least one electrical signal using an Optical Network Terminal (ONT). The ONT may split the resultant electrical signal into separate services required by the subscriber such as computer networking (data), telephony and video.

In FTTC and FTTN networks, the optical signal is converted to at least one electrical signal by either an Optical Network Unit (ONU) (FTTC) or a Remote Terminal (RT) (FTTN), before being provided to a subscriber's premises.

A typical FTTx network often includes one or more Optical Line Terminals (OLTs), which each include one or more Passive Optical Network (PON) cards. Such a typical network is illustrated in FIG. 1. Each OLT typically is communicatively coupled to one or more ONTs (in the case of a FTTP network), or to one or more Optical Network Units (ONUs) (in the case of a FTTC network), via an Optical Distribution Network (ODN). In a FTTP network the ONTs are communicatively coupled to customer premises equipment (CPE) used by end users (e.g., customers or subscribers) of network services. In a FTTC network, the ONUs are communicatively coupled to network terminals (NTs), and the NTs are communicatively coupled to CPE. NTs can be, for example, digital subscriber line (DSL) modems, asynchronous DSL (ADSL) modems, very high speed DSL (VDSL) modems, or the like.

In a FTTN network, each OLT typically can be communicatively coupled to one or more RTs. The RTs are communicatively coupled to NTs that are communicatively coupled to CPE.

OLTs communicate with ONTs (in the case of a FTTP network), or ONUs (in the case of a FTTC network) using the ONT Management and Control Interface (OMCI) control protocol as specified in ITU-T G.983.2 and ITU-T G.984.4. An OMCI Management Information Base (MIB), included in each device communicating using the OMCI protocol, defines the format of messages exchanged using the OMCI protocol.

An OLT can send an OMCI control message that controls an ONT or OLT to provide a service (e.g., a voice, data, and/or video service) by establishing a connection through which data is delivered from the OLT to CPE via the ONT or ONU. The ONT or ONU can send the OLT OMCI notification messages to notify the OLT of alarms.

Typically, the OMCI MIBs of OLTs and ONTs/ONUs are matched to define message formats in the same manner so that a message sent by one device can be properly processed by the receiving device. Otherwise, if the OMCI MIBs of OLTs and ONTs/ONUs define message formats differently, thus creating a MIB mismatch, a message sent by one device may not be supported by the receiving device. Typically, if an OLT, ONT, or ONU does not support a received message, the device may reject the entire message.

### BRIEF DESCRIPTION

The inventors have recognized that when new devices (e.g., ONTs, ONUs, and/or OLTs) are added to a network, communication errors may occur because of mismatches between messages supported by the newly added devices and messages supported by pre-existing devices in the network. These mismatches may occur because, for example, the newly added devices include new software releases, the newly added devices and the pre-existing devices are manufactured by different vendors, or because the newly added devices are new products, and thus generate and process messages in a different manner than the pre-existing devices.

Because these devices typically reject unsupported messages without providing additional error processing, when a network error occurs because of an unsupported message, it may be difficult to determine that the error is due to unsupported error messages and not due to some other cause.

The example embodiments described herein overcome the above-identified limitations by providing a method, and an apparatus, system, and sequences of instructions that operate in accordance with the method, for identifying errors in communications in a system that provides services (e.g., voice, data, and/or video services).

According to an example aspect of the invention, a network device includes at least one communications interface adapted to communicate with at least one controlling device using a control protocol. The controlling device controls the network device to provide at least one service. A processor of the network device is operable to (i) receive a control message from the controlling device by way of the communications interface, (ii) determine whether the control message is a supported message, (iii) generate error information if the control message is not a supported message, and (iv) store the error information in a memory of the network device. The controlling device includes at least one communications interface, and a processor operable to (i) receive a notification message from the network device, (ii) determine whether the notification message is a supported message, (iii) generate error information if the notification message is not a supported message, and (iv) store the error information in a memory of the controlling device.

By virtue of storing error information generated in response to receiving an unsupported message, the network device and/or the controlling device enables a technician or a network management system to more easily isolate and identify network errors caused by unsupported error messages.

The network device can be, for example, one of an Optical Network Terminal (ONT) and an Optical Network Unit (ONU), and the controlling device can be, for example, an Optical Line Terminal (OLT), although in other embodiments, other types of devices can be employed.

The control messages can include at least a provisioning message for provisioning a service. The notification message can include at least an alarm. The control message and the notification message can include an Optical Network Terminal (ONT) Management and Control Interface (OMCI) control message, the memory of the network device can store an OMCI Management Information Base (MIB), and the memory of the controlling device can include an OMCI MIB.

The processor of the network device and the processor of the control device can provide the error information to a test device in response to a query from the test device by way of the communications interface. The processor of the network device can provide the error information to the controlling device. The processor of the controlling device can provide the error information to an Element Management System (EMS) by way of the communications interface.

The unsupported control message can be at least one of a control message having an unsupported format, a control message including at least one unsupported attribute, and a control message including at least one unsupported attribute value. The unsupported notification message can be a message that includes an unknown alarm.

According to an example aspect of the invention, error information generated in response to an unsupported control message being received from at least one controlling device of the system is stored in at least one network device. The error information stored in the network device is retrieved, and errors in communications between the network device and the controlling device are identified, based on the error information retrieved.

By virtue of storing error information generated in response to receiving an unsupported message, a technician or a network management system can more easily isolate and identify network errors caused by unsupported error messages.

Control messages can be generated and sent to the at least one network device. Error information can be generated in response to an unsupported notification message being received at the controlling device, and the error information can be stored in the controlling device. The error information stored in the controlling device can be retrieved. Errors in communications can be identified based on the error information retrieved from the controlling device, and the error information retrieved from the network device.

By virtue of testing network devices in a test environment in the foregoing manner, potential communication errors can be identified before deploying the network device in the field. By identifying potential communication errors, manufacturers can redesign their network devices so that communication errors can be reduced or minimized when these network devices are deployed in the field.

The system can be a test system in a test environment operated by a testing service provider, and the testing service provider can be compensated for operating the system.

A manufacturer of the controlling device of the system can request the testing service provider to test the system, and the manufacturer can compensate the testing service provider for operating the system.

A manufacturer of the network device of the system can request the testing service provider to test the system, and the manufacturer can compensate the testing service provider for operating the system.

A service provider of a service provided by the system can request the testing service provider to test the system, and the service provider can compensate the testing service provider for operating the system.

A manufacturer of a network device of the system can compensate the service provider for requesting the testing service provider to test the system.

The testing service provider can manufacture at least one controlling device of the system, and a manufacturer of the network device of the system can compensate the testing service provider by paying the testing service provider a royalty fee for each network device deployed in the system that communicates with a controlling device deployed in the system and manufactured by the testing service provider.

Further features and advantages, as well as the structure and operation, of various example embodiments of the invention are described in detail below with reference to the accompanying drawings.

### BRIEF DESCRIPTION OF THE DRAWINGS

The features and advantages of the example embodiments of the invention presented herein will become more apparent from the detailed description set forth below when taken in conjunction with the drawings in which like reference numbers indicate identical or functionally similar elements:

FIG. 1 represents a conventional FTTx network.

FIG. 2 is a network diagram of an example passive optical network (PON).

FIG. 3 is an architecture diagram of a data processing system in accordance with an example embodiment of the invention.

FIG. 4 (formed of FIGS. 4A and 4B) is a flow diagram that illustrates a method for handling unsupported messages received by a network device in accordance with an example embodiment of the invention.

FIG. 5 is a flow diagram that illustrates a method for handling unsupported messages received by a controlling device in accordance with an example embodiment of the invention.

FIG. 6 is a flow diagram that illustrates a method for identifying communications errors in accordance with an example embodiment of the invention.

FIG. 7 is a flow diagram that illustrates a method for identifying communications errors in accordance with an example embodiment of the invention.

FIG. 8 is a flow diagram that illustrates a method for identifying communications errors in accordance with an example embodiment of the invention.

FIG. 9 is a logical diagram of functional modules in accordance with an example embodiment of the invention.

Identically labeled elements appearing in different ones of the figures refer to the same elements but may not be referenced in the description for all figures.

### DETAILED DESCRIPTION

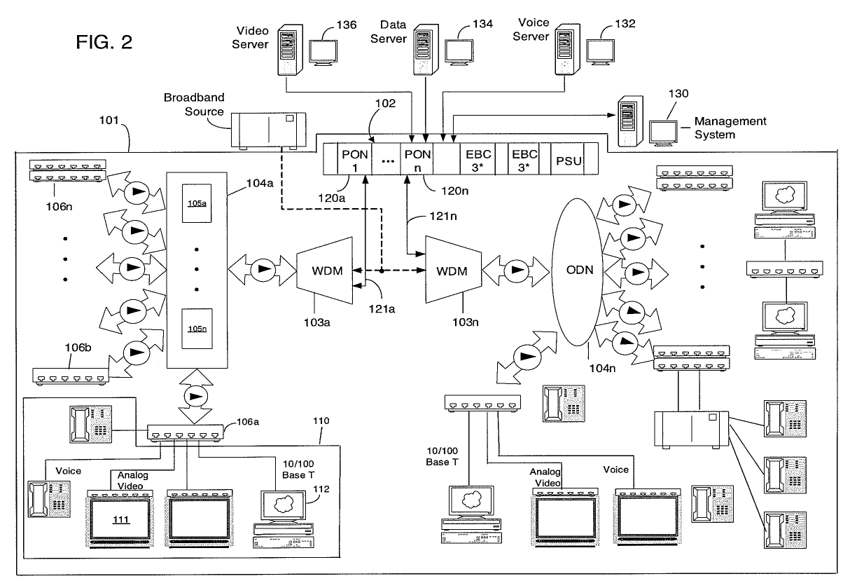

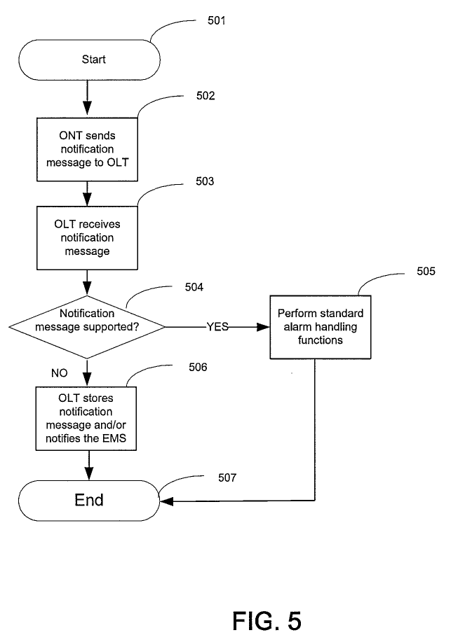

FIG. 2 is a network diagram of an example system or network that is suitable for practicing example aspects of this invention. A Passive Optical Network (PON) 101 of the system includes an optical line terminal (OLT) 102, wavelength division multiplexers 103a-n, optical distribution network (ODN) devices 104a-n, ODN device splitters (e.g., 105a-n associated with ODN device 104a), optical network terminals (ONTs) (e.g., 106-n corresponding to ODN device splitters 105a-n), and customer premises equipment (e.g., 110). The OLT 102 includes PON cards 120a-n, each of which provides an optical feed (121a-n) to ODN devices 104a-n. Optical feed 121a, for example, is distributed through corresponding ODN device 104a by separate ODN device splitters 105a-n to respective ONTs 106a-n, in order to provide communications to and from customer premises equipment 110 operably coupled to a port (e.g., 320 of FIG. 5) of the ONT.

The PON 101 may be deployed for fiber-to-the-business (FTTB), fiber-to-the-curb (FTTC), and fiber-to-the-home (FTTH) applications, for example. The optical feeds 121a-n in PON 101 may operate at bandwidths such as 155 Mb/sec, 622 Mb/sec, 1.25 Gb/sec, and 2.5 Gb/sec or any other desired bandwidth implementations. The PON 101 may incorporate, for example, ATM communications, broadband services such as Ethernet access and video distribution, Ethernet point-to-multipoint topologies, BPON communications, GPON communications, EPON communications, and native communications of data and time division multiplex (TDM) formats. Customer premises equipment (e.g., 110), which can receive and provide communications in the PON 101, may include standard telephones (e.g., Public Switched Telephone Network (PSTN)), Internet Protocol telephones, Ethernet units, video devices (e.g., 111), computer terminals (e.g., 112), digital subscriber line connections, cable modems, wireless access, as well as any other type of customer premise equipment.

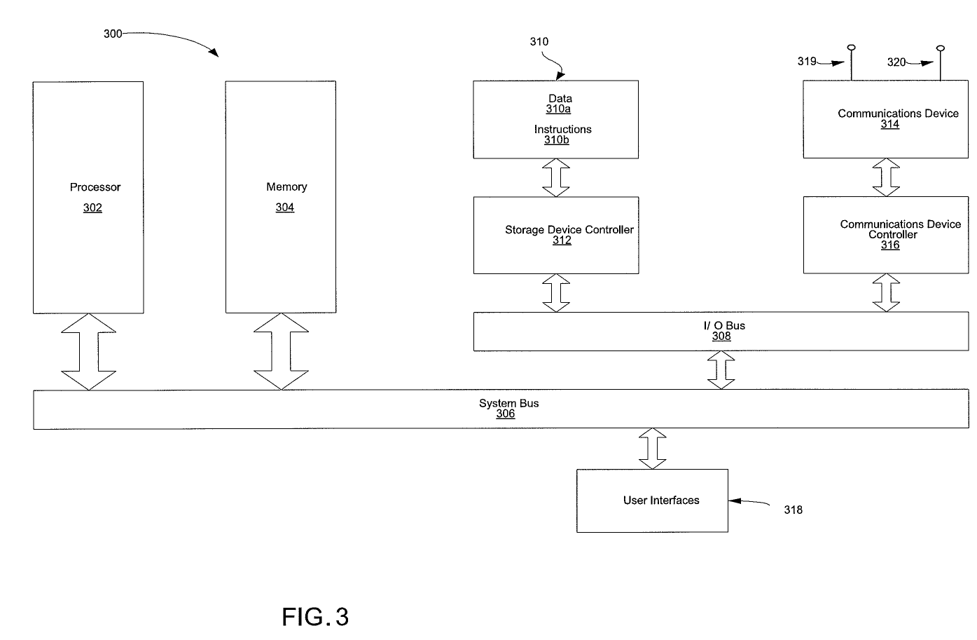

PON 101 can include one or more different types of ONTs (e.g., 106a-n). Each ONT 106a-n, for example, is operably coupled with an ODN device 104a through associated ODN device splitters 105a-n via a data port (i.e., 319 of FIG. 3). Each ODN device 104a-n in turn communicates with an associated PON card 120a-n through respective wavelength division multiplexers 103a-n. Wavelength division multiplexers 103a-n are optional components that are used when video services are provided. Communications between the ODN devices 104a-n and the OLT 102 occur over a downstream wavelength and an upstream wavelength. The downstream communications from the OLT 102 to the ODN devices 104a-n may be provided at, for example, 622 megabytes per second, which is shared across all ONTs connected to the ODN devices 104a-n. The upstream communications from the ODN devices 104a-n to the PON cards 120a-n may be provided at, for example, 155 megabytes per second, which is shared among all ONTs connected to ODN devices 104a-n, although example embodiments of the invention are not limited to those specific types of downstream and upstream communications only, and may also include the types of example communications referred to above or any other suitable types of communications.

FIG. 2 further illustrates the OLT 102 managed by an element management system (EMS) 130. Since the OLT 102 includes the PON cards 120a-n, each PON card 120a-n is also managed by the EMS 130. As such, a single EMS manages all PON cards within a PON.

A single EMS, however, may manage or otherwise be associated with more than one PON. As such, a single EMS is not limited to managing PON cards within a single PON, but may manage PON cards from several PONs. In other example embodiments, more than one EMS can be employed to manage one or more PON cards within a single PON or plural PONs.

FIG. 2. also illustrates plural servers, such as, for example, a server 132 that supports voice applications, a server 134 that supports data applications, and a server 136 that supports video applications, although in other example embodiments the functionality of those servers may be performed by only a single server or by a combination of servers. In still other example embodiments, the servers 132, 134, 136, and/or EMS 130 can be formed by a single server device or a combination of server devices, or no EMS 130 need be provided and the functionality of the EMS 130 can be provided by the servers 132, 134, and 136.

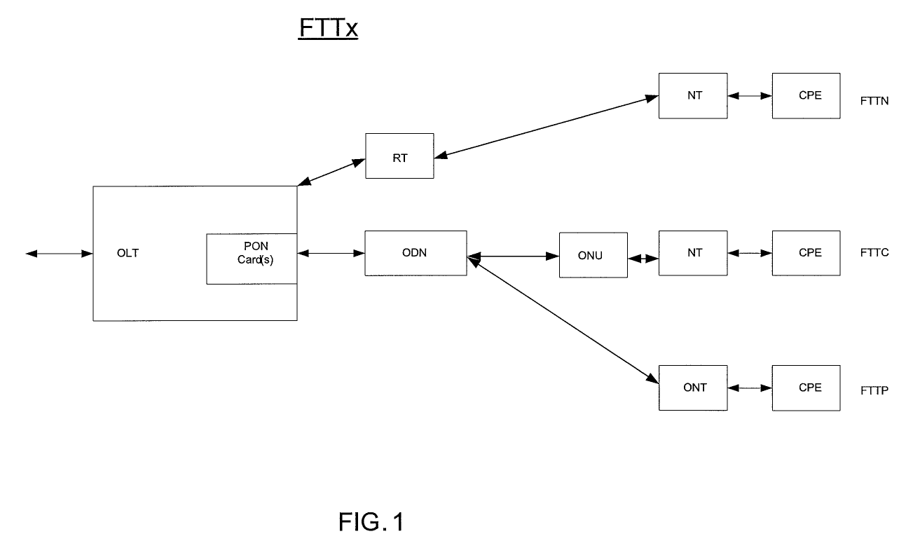

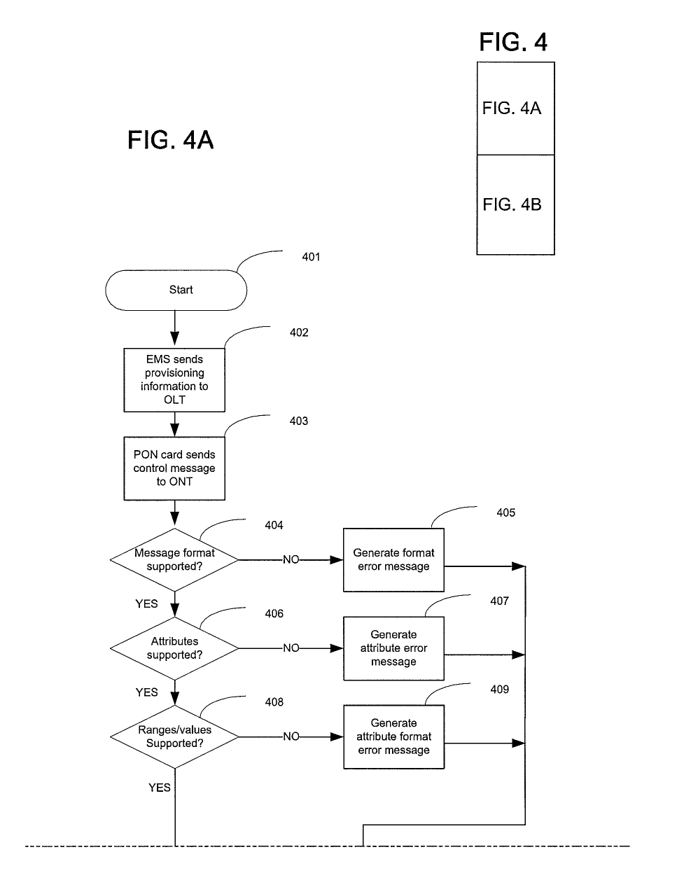

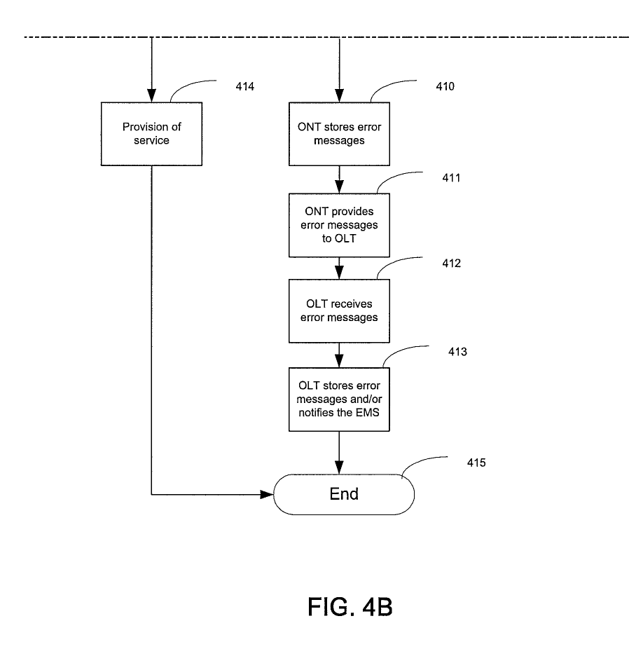

FIG. 3 is an architecture diagram of an example data processing system or device 300, which, according to an example embodiment, can form individual ones of the ONU, ONT, OLT, ODN, NT, RT, and CPE of FIG. 1, and components 102, 104a-n, 106a-n, 110, 130, 132, 134, and 136 of FIG. 2, and/or any other type of a network device supporting a network control protocol, such as, for example, ONT Management and Control Interface (OMCI). Data processing system 300 includes a processor 302 coupled to a memory 304 via system bus 306. Processor 302 is also coupled to external Input/Output (I/O) devices (not shown) via the system bus 306 and an I/O bus 308, and at least one input/output user interface 318. Processor 302 may be further coupled to a communications interface 314 via a communications interface controller 316 coupled to the I/O bus 308. Processor 302 uses the communications interface 314 to communicate with a network, such as, for example, the network as shown in FIG. 2. In the case of at least the ONTs 106a-n, interface 314 has data port 319 operably coupled to a network (e.g., PON 101) for sending and receiving data, and voice services data port 320 operably coupled to customer premises equipment (e.g., 110) for sending and receiving voice data, but interface 314 may also have one or more additional input and output ports. A storage device 310 having a computer-readable medium is coupled to the processor 302 via a storage device controller 312 and the I/O bus 308 and the system bus 306. The storage device 310 is used by the processor 302 and controller 312 to store and read/write data 310a, and to store program instructions 310b used to implement the procedures described below in connection with FIGS. 4 to 8. The storage device 310 also stores various routines and operating programs (e.g., Microsoft Windows, UNIX/LINUX, or OS/2) that are used by the processor 302 for controlling the overall operation of the system 300. In the case of a network device supporting a control protocol (e.g., ONU of FIG. 1 and OLTs 102, ONTs 106a-n of FIG. 2), at least one of the programs stored in storage device 310 adheres to a control protocol (e.g., OMCI), for exchanging control messages and notification messages, and data 310a includes at least an OMCI Management Information Base (MIB) that defines the format of messages exchanged using the OMCI protocol. At least one of the programs (e.g., Microsoft Winsock) stored in storage device 310 can adhere to TCP/IP protocols (i.e., includes a TCP/IP stack), for implementing a known method for connecting to the Internet or another network.

In operation, processor 302 loads the program instructions 310b from the storage device 310 into the memory 304. Processor 302 then executes the loaded program instructions 310b to perform any of the example methods described below, for operating the system 300 (which forms individual ones of the components, such as, an ONU, ONTs 106a-n, OLTs 102, and other devices supporting a control protocol).

According to an example aspect of the invention, in the case of at least a network device (e.g., ONU of FIG. 1 and ONTs 106a-n of FIG. 2), the instructions 310b stored in the storage device 310 also include instructions that, when executed by the processor 302, enable the system 300 to (i) receive a control message from a controlling device (e.g., OLT 102), (ii) determine whether the control message is a supported message, (iii) generate error information if the control message is not a supported message, (iv) store the error information in a memory of the network device, and (v) provide the error information to a test device in response to a query from the test device.

In the case of at least a controlling device (e.g., OLT 102 of FIG. 2), the instructions 310b stored in the storage device 310 also include instructions that, when executed by the processor 302, enable the system 300 to (i) generate control messages, (ii) send generated control messages to a network device (e.g., ONU of FIG. 1 and ONTs 106a-n of FIG. 2), (iii) receive a notification message from the network device, (iv) determine whether the notification message is a supported message, (v) generate error information if the notification message is not a supported message, (vi) store the error information in a memory of the controlling device, and (vii) provide the error information to a test device in response to a query from the test device.

As but a non-limiting example, control messages can include at least provisioning messages for provisioning at least one service (e.g., a voice, data, and/or video service). As another non-limiting example, notification messages can include at least alarms, according to, for example, the OMCI protocol.

FIG. 4, which is formed of a combination of FIGS. 4A and 4A, is a flow diagram that illustrates a method for handling unsupported messages received by a network device. In an example embodiment of the invention described with respect to FIG. 4, the network device is an ONT (e.g., 106a-n of FIG. 2) that communicates with an OLT (e.g., 102 of FIG. 2) using the OMCI control protocol. The OLT and the ONT use the OMCI protocol to exchange messages for providing at least one service (e.g., voice, data, and/or video service(s)) to customer premises equipment (e.g., 110 of FIG. 2). In other example embodiments of this invention, the network device can be any other network device, such as, for example, an ONU (e.g., ONU of FIG. 1) that provides a service and is controlled by a controlling device using a control protocol.

An element management system (EMS) (e.g., 130 of FIG. 2) in communication with the OLT provides the OLT with information used to control the ONT to provide the service(s), although in other embodiments the OLT can obtain that information from another source or can have that information pre-programmed in its memory.

At block 401, the EMS receives configuration instructions, via the EMSs user interface (e.g., 318 of FIG. 3), for provisioning a service at the ONT. In response to receiving these instructions, the EMS generates and sends provisioning information to the OLT (e.g., 102) and to a PON card of the OLT (e.g., 120 a-n of FIG. 2) in communication with the ONT (block 402). In response to receiving the provisioning information from the EMS, the PON card generates at least one OMCI control message based on the received provisioning information, and sends the generated OMCI control message(s) to the ONT (block 403).

At block 404, a processor of the ONT determines whether a received message is a supported message. A received message is supported if the ONT understands the format of the message, supports the attributes or parameters included in the message, and supports ranges or values specified for the attributes/parameters included in the message. For example, in response to receiving a message from the PON card of the OLT, the processor of the ONT determines the type of the received message. The processor of the ONT then retrieves MIB information corresponding to the type of the received message from the ONTs OMCI MIB, and determines whether the received message is supported based on the retrieved MIB information.

The retrieved MIB information defines the format, supported attributes, and supported attribute ranges/values for each supported attribute for the message type corresponding to the received message. By comparing the format, included attributes, and specified ranges or values specified for the attributes included in the message with the corresponding format, supported attributes, and supported attribute ranges/values, respectively, defined in the retrieved MIB information, the processor of the ONT determines whether the received message is supported.

If the format of the message is not supported (“NO” at block 404), the processor of the ONT generates a message format error message (block 405), and thereafter processing proceeds to block 410. If the format of the message is supported (“YES” at block 404), processing proceeds to block 406 where the processor determines whether attributes included in the message are supported.

If attributes included in the message are not supported (“NO” at block 406), the processor of the ONT generates an attribute error message (block 407), and thereafter processing proceeds to block 410. If the attributes included in the message are supported (“YES” at block 406), processing proceeds to block 408 where the processor determines whether the ranges or values specified for attributes in the message are supported.

If the ranges or values specified for attributes in the message are supported (“YES” at block 408), processing proceeds to block 414 where the service specified in the received message is provisioned. Thereafter, processing proceeds to block 415 and ends.

If the ranges or values specified for attributes in the message are not supported (“NO” at block 408), the processor of the ONT generates an attribute format error message (block 409), and thereafter processing proceeds to block 410.

At block 410, the processor of the ONT adds other relevant information to the error messages generated at blocks 405, 407, and/or 409, such as, for example, the unsupported message, a timestamp, an ONT state including alarms and an ONT provisioned state, and any other relevant information. The generated error messages, including any relevant information, are stored in a memory of the ONT, such as for example, a flash memory.

At block 411, the processor of the ONT provides the generated error messages, including any relevant information added at block 410, to the OLT, via the OLT's PON card. In response to receiving the error messages (block 412), a processor of the OLT notifies the EMS of the received error messages, providing any relevant information including the received error messages, and/or stores the received error messages in a memory of the OLT, such as for example, a flash memory (block 413). The OLT adds other relevant information to stored error messages, such as, for example, a timestamp indicating the time the OLT received the error messages, information identifying the ONT that sent the messages, an ONT state including alarms and an ONT provisioned state, and any other relevant information. After the processor of the OLT notifies the EMS and/or stores the received error messages, processing proceeds to block 415 and ends.

FIG. 5 is a flow diagram that illustrates a method for handling unsupported messages received by a controlling device. In an example embodiment of the invention described with respect to FIG. 5, the controlling device is an OLT (e.g., 102 of FIG. 2) that communicates with an ONT (e.g., 106a-n of FIG. 2) using the OMCI control protocol. In other example embodiments of this invention, the controlling device can be any other controlling device that uses a control protocol to control any other network device.

The OLT controls the ONT to provide at least one service (e.g., voice, data, and/or video service(s)) to customer premises equipment (e.g., 110 of FIG. 2). The ONT sends notification messages to the OLT to report alarms indicating problems.

At block 501, the ONT detects a problem, such as, for example, a problem with the ONT hardware and/or software, a problem with the customer premises equipment, a problem with the interface between the ONT and the customer premises equipment, and any other type of problem. At block 502, the ONT generates an alarm and sends a notification message reporting the alarm to the OLT. In response to receiving the notification message from the ONT (block 503), a processor of the OLT determines whether the received notification message is a supported notification message (block 504).

The processor of the OLT determines whether the received message is a supported message by determining whether the alarm reported in the notification message is defined in the OMCI MIB of the OLT. If the received notification message is a supported notification message (“YES” at block 504), the processor of the OLT performs standard alarm handling functions for handling the alarm reported in the notification message (block 505). Thereafter processing proceeds to block 507 and ends.

If the received notification message is not a supported notification message (“NO” at block 504), the processor of the OLT notifies an EMS, communicatively coupled to the OLT (e.g., 130 of FIG. 2), that it received an unsupported notification message, and provides any relevant information including the received notification message, and/or stores the received notification message in a memory of the OLT, such as for example, a flash memory (block 506). The OLT can add other relevant information to the stored notification message, such as, for example, the unsupported message, a timestamp indicating the time OLT received the notification message, information identifying the ONT that sent the message, the ONT state including other alarms and an ONT provisioned state, and any other relevant information. After the processor of the OLT notifies the EMS and/or stores the received notification message, processing proceeds to block 507 and ends.

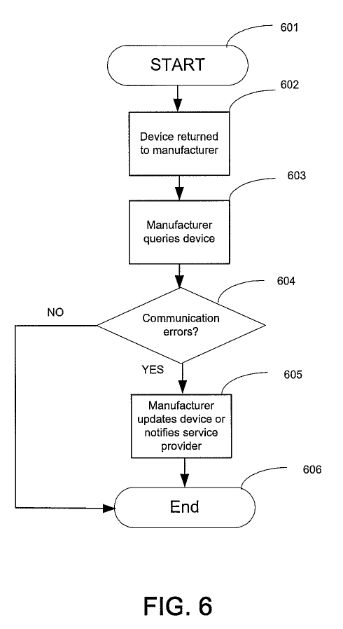

FIG. 6 is a flow diagram that illustrates a method for troubleshooting errors occurring in a system deployed in the field. Network devices and/or controlling devices deployed in the field are returned to their respective manufacturers to determine whether the error is due to a communication error between the device and another device deployed in the field, such as for example, a network device or a controlling device. FIG. 6 describes the method with respect to identifying unsupported messages received by either a network device or a controlling device, based on the error information stored in the device according to the methods described above with respect to FIG. 4 (describing storing error information in the network device) and FIG. 5 (describing storing error information in controlling device).

In response to a problem in the field (block 601), the device is returned to the manufacturer (block 602) to determine whether the problem is due to the exchange of unsupported messages between the network device and the controlling device, or due to a more serious problem, such as for example, a manufacturing defect.

At block 603, the manufacturer queries the device to retrieve the error information stored in the device, which is used to troubleshoot the problem. At block 604, the manufacturer identifies communication errors caused by unsupported messages based on the retrieved error information.

For example, if there is a mismatch between the OMCI MIB of the network device and the OMCI MIB of the controlling device deployed in the field, the network device and the controlling device may exchange unsupported messages in the field. In response to receiving an unsupported message, the network device and/or the controlling device generate and store error information, as described above with respect to FIGS. 4 and 5. When either the network device or the controlling device is returned to the manufacturer, the manufacturer retrieves error information stored in response to receiving an unsupported message. By examining the error information, which may include the unsupported message, or an indication that an unsupported message was received, the manufacturer can determine whether the problem in the field was due to a communication error caused by, for example, an MIB mismatch.

If the manufacturer does not identify any communications errors (“NO” at block 604), the process of identifying communication errors ends (block 606). If the manufacturer identifies any communications error(s) (“YES” at block 604), the manufacture either updates the hardware and/or software of the device to correct the problem that generated the error(s), or notifies the service provider using the device in the field to modify the operation of their network (e.g., 101 of FIG. 2) such that the device no longer receives the unsupported messages (block 605). Thereafter, the process of identifying communication errors ends (block 606).

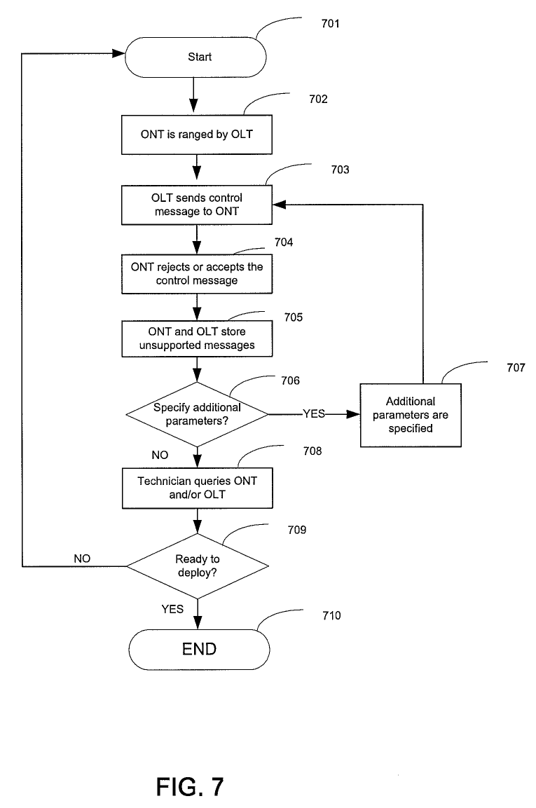

FIG. 7 is a flow diagram that illustrates a method for performing interoperability testing between at least one network device and at least one controlling device before including the network device and/or the controlling device in a system deployed in the field. FIG. 7 describes the method with respect to performing the interoperability testing in a test environment, wherein the network device and the controlling device are included in a test system that simulates the operation of the system deployed in the field. The interoperability testing can be performed by, for example, a testing service provider to determine the full ranges of messages supported by the network device and/or the controlling device. The results of this testing can be used to identify potential communication errors cased by the exchange of unsupported messages between these devices before the network device and/or controlling device are deployed in the field. Interoperability testing can be performed between devices of different manufacturers or devices of the same manufacture. For example, when a manufacturer develops a new device, such as, for example, an existing product with a new software version, or a new product, the new device can be tested to determine whether the device can interoperate with the manufacturer's existing devices in a system without causing communication errors.

The network device and the controlling device perform the methods described above with respect to FIG. 4 and FIG. 5, respectively, for storing error information in response to receiving an unsupported message. FIG. 7. describes the method with respect to performing interoperability testing between an ONT (e.g., 106a-n of FIG. 2) and an OLT (e.g., 102 of FIG. 2), but in other example embodiments of the invention, interoperability testing can be performed between any other types of network devices and controlling devices.

At block 701, a test technician begins performing interoperability testing between the ONT and the OLT. At block 702, both devices are connected, and the test technician sends the OLT configuration instructions, via the OLT's user interface (e.g., 318 of FIG. 3), for beginning the interoperability tests. In response to receiving the instructions, the OLT performs ranging of the ONT by sending the ONT a control message.

At block 703, the OLT generates at least one OMCI control message for provisioning or querying specific parameters (e.g., status and read-only parameters) within the full set of available parameters, and sends the generated OMCI control message(s) to the ONT. In an example embodiment of the invention, these parameters are specified in instructions received by the test technician via the OLT's user interface. In another example embodiment of the invention, these parameters are automatically specified by program instructions 310b stored in the OLT, which are executed by the OLT's processor 302, in response to receiving the instructions for beginning the interoperability tests provided by the test technician at block 702.

At block 704, the ONT receives the OMCI control message(s) generated at block 703. If the received message(s) is unsupported, the ONT rejects the message(s), whereas if the message(s) is supported, the ONT accepts the message(s). At block 705, the ONT stores error information corresponding to any received unsupported control messages in accordance with the method described above with respect to FIG. 4. Additionally, the ONT may send the OLT a notification message reporting any alarms generated by the ONT. The OLT stores error information corresponding to any received unsupported notification messages in accordance with the method described above with respect to FIG. 5.

At block 706, it is determined whether additional parameters are to be provisioned or queried by the OLT. If additional parameters are to be provisioned or queried by the OLT (“YES” at block 706), additional parameters within the full set of available parameters are specified (block 707), and thereafter the OLT performs the process described above with respect to block 703 using these newly specified parameters. In an example embodiment of the invention, the test technician determines whether additional parameters are to be provisioned or queried by the OLT at block 706, and if so, uses the OLT's user interface to manually specify these additional parameters. In another example embodiment of the invention, the OLT's processor determines whether additional parameters are to be provisioned or queried by the OLT at block 706, based on instructions 310b stored on the OLT, and, if so, automatically specifies these additional parameters.

If additional parameters are not to be queried by the OLT (“NO” at block 706), the test technician queries the ONT and/or the OLT to retrieve any error information stored in either device at block 708. Based on the retrieved error information, the test technician generates a report indicating any unsupported messages exchanged between the ONT and the OLT. If there is no error information, the test technician generates a report indicating that the ONT and/or OLT is ready to be deployed in the field.

The test technician can query this information using the user interface (e.g., 318 of FIG. 3) of these devices, or the test technician can use a test device to query this information. The test device can be, for example, a computer (e.g., a device 300 of FIG. 3) communicatively coupled to the ONT or the OLT, and the processor of the ONT or the OLT sends the error information to the test device in response to receiving the query information from the test device.

At block 709, the test technician sends the report to either the manufacturer of the ONT and/or the manufacturer of the OLT. Based on the report, the manufacturer(s) may modify the software and/or hardware of the OLT and/or the ONT to correct the errors identified during the interoperability testing, or if the report indicates that there are no errors, proceed to deploy the device(s) in the field.

If the devices are ready to be deployed (“YES” at block 709), interoperability testing is complete (block 710). If the devices need to be modified (“NO” at block 709), the devices are modified and the interoperability tests are performed using the modified devices (block 701).

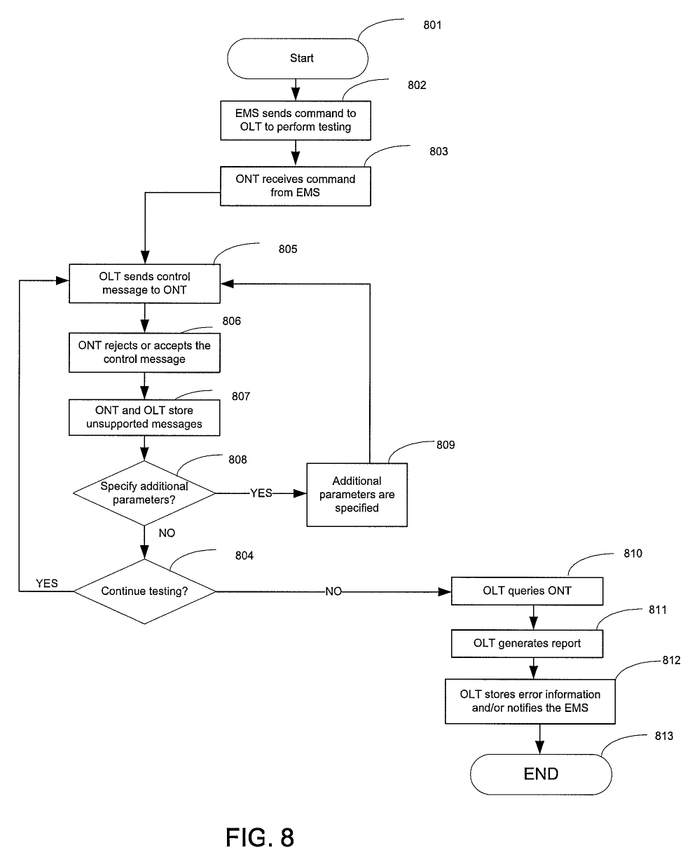

FIG. 8 is a flow diagram that illustrates an automated method for performing the functions described above for FIG. 7, for testing communications between one or more ONTs and an OLT in a test system. For example, a test technician operating an EMS (e.g., 130 of FIG. 2), or any other system that manages the test system, can command an automated interoperability test to be performed. In response to a command from the EMS, the OLT sends control messages to an ONT that provisions or queries the full set of parameters or attributes supported by the ONT. After sending all the control messages, the OLT queries the ONT to retrieve stored error information and provides a pass/fail report indicating whether the ONT is capable of interoperating with the OLT in a system deployed in the field. In other example embodiments, communications between any other types of network devices and controlling devices can be tested.

At block 801, a test technician operating an EMS (e.g., 130 of FIG. 2) commands an automated interoperability test to be performed. At block 802, the EMS sends a command to the OLT to perform one or more tests that test the full range of attributes/parameters supported by the ONT. At block 803, the OLT receives the command from the EMS and sends control messages to an ONT that provision or query the full set of attributes or parameters supported by the ONT.

At block 805, the OLT generates at least one OMCI control message for provisioning or querying specific parameters (attributes) (e.g., status and read-only parameters) within the full set of available parameters, and sends the generated OMCI control message(s) to the ONT. These parameters are automatically specified by program instructions 310b stored in the OLT, which are executed by the OLT's processor 302, in response to receiving the instructions for beginning the interoperability tests provided by the EMS at block 803.

At block 806, the ONT receives the OMCI control message(s) generated at block 805. If the received message(s) is unsupported, the ONT rejects the message(s), whereas if the message(s) is supported, the ONT accepts the message(s). At block 807, the ONT stores error information corresponding to any received unsupported control message(s) in accordance with the method described above with respect to FIG. 4. Additionally, the ONT may send the OLT a notification message reporting any alarm(s) generated by the ONT. The OLT stores error information corresponding to any received unsupported notification messages in accordance with the method described above with respect to FIG. 5.

At block 808, it is determined whether additional parameters are to be provisioned or queried by the OLT. If additional parameters are to be provisioned or queried by the OLT (“YES” at block 808), additional parameters within the full set of available parameters are specified (block 809) and thereafter the OLT performs the process described above with respect to block 805 using these newly specified parameters. The OLT's processor determines whether additional parameters are to be provisioned or queried by the OLT at block 808, based on instructions 310b stored on the OLT, and if so, automatically specifies these additional parameters.

If additional parameters are not to be queried by the OLT (“NO” at block 808), the OLT's processor determines whether the interoperability tests should be repeated (block 804), based on the command received from the EMS at block 803. If the interoperability tests are to be repeated (“YES” at block 804), processing returns to block 805.

If the interoperability tests are not to be repeated (“NO” at block 804), processing proceeds to block 810 where the OLT queries the ONT to retrieve any error information stored in the ONT at block 807. Based on the retrieved error information, and the error information stored locally on the OLT, the OLT generates a pass/fail report indicating whether the ONT is capable of interoperating with the OLT in a system deployed in the field (block 811).

At block 812 the OLT notifies the EMS if any error information was retrieved from the ONT (or generated at the OLT) and/or provides the report generated at block 811. In addition to, or in place of, notifying the EMS, the OLT stores any retrieved or generated error information in a memory of the OLT, such as, for example, a flash memory. The OLT also can add other relevant information to stored notification messages, such as, for example, a timestamp indicating the time the OLT received or generated error information, information identifying which ONTs contained stored error information, an ONT state including other alarms and an ONT provisioned state, and any other relevant information. After the OLT notifies the EMS and/or stores the error information, processing proceeds to block 813 and ends.

In an example aspect of the invention, the methods described above for FIGS. 7 and 8 are performed by a testing service provider that, for example, charges a fee for performing the testing service. For example, an ONT manufacturer requests the testing service provider to test the manufacturer's ONT in a system that emulates the system of a service provider that is a potential customer of the manufacturer. In exchange, the ONT manufacturer pays the testing service provider a fee. Similarly, an OLT manufacturer of can request testing services.

In another example aspect of the invention, a service provider requests the testing service provider to test a system, and the service provider compensates the testing service provider for performing the testing. For example, if a service provider wants to deploy, for example, new ONT or OLT devices in the field, the service provider pays the testing service provider to perform tests in a test environment to determine whether the new device can operate in the field. Furthermore, a manufacturer of this new device (e.g., ONT or OLT) compensates the service provider if the service provider requests the testing service provider to test the system on the manufacturer's behalf.

In another example aspect of the invention, a manufacturer of a controlling device (Manufacturer A), such as, for example, an OLT, performs interoperability testing between the manufacturer's device and a network device, such as, for example, an ONT, developed by another manufacturer (Manufacturer B). Manufacturer B compensates Manufacturer A by paying Manufacturer A a royalty fee for each deployed ONT made by Manufacturer B that communicates with a deployed controlling device, made by Manufacturer A, in a system that provides services.

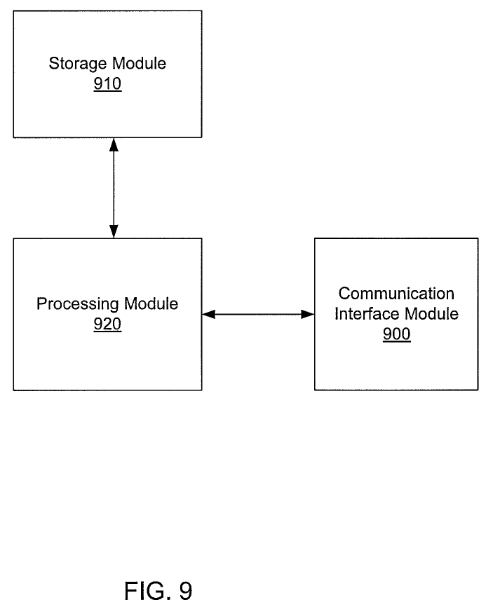

FIG. 9 is a logical diagram of modules in accordance with an example embodiment of the invention. The modules may be of a data processing system or device 300, which, according to an example embodiment, can form individual ones of the ONU, ONT, OLT, ODN, NT, RT, and CPE of FIG. 1 and components 102, 104a-n, 106a-n, 110, 130, 132, 134, and 136 of FIG. 2, and/or any other type of a network device supporting a network control protocol, such as, for example, ONT Management and Control Interface (OMCI). The modules may be implemented using hardcoded computational modules or other types of circuitry, or a combination of software and circuitry modules.

A communication interface module 900 controls a communications interface 314 by processing interface commands. The interface commands may be, for example, commands to send data, commands to communicatively couple with another device, or any other suitable type of interface command.

A storage module 910 stores and retrieves data (e.g., error information) in response to requests from the processing module 920.

In the case of a network device supporting a control protocol (e.g., ONU of FIG. 1 and OLTs 102, ONTs 106a-n of FIG. 2), the processing module 920 performs the procedures as described above in connection with FIG. 4. The processing module 920 receives a control message from a controlling device (e.g., OLT 102) via the communication interface module 900. The processing module 920 determines whether the control message is a supported message, generates error information if the control message is not a supported message, and stores the error information in the storage module 910. In response to receiving a query from a test device via the communication interface module 900, the processing module 920 retrieves the error information from the storage module 910, and provides the error information to the test device via the communication interface module 900.

In the case of at least a controlling device (e.g., OLT 102 of FIG. 2), the processing module 920 performs the procedures as described above in connection with FIGS. 5, 7, and 8. The processing module 920 receives notification messages from network devices via the communication interface module 900. In response to receiving a notification message, the processing module 920 determines whether the notification message is a supported message. If the notification message is not supported, the processing module 920 generates error information and stores the error information in the storage module 910. In response to receiving a query from a test device via the communication interface module 900, the processing module 920 retrieves the error information from the storage module 910 and provides the error information to the test device, via the communication interface module 900.

The processing module 920 receives instructions from, for example, an EMS (e.g., 130 of FIG. 3) or a user interface communicatively coupled with the communication interface module 900. In response to receiving instructions via the communication interface module 900, the processing module 920 generates control messages and sends the generated control messages to a network device (e.g., ONU of FIG. 1 and ONTs 106a-n of FIG. 2) via the communication interface module 900. The processing module 920 queries network devices, using the communications interface module 900, to retrieve stored error information. Based on retrieved error information from the network devices, and error information retrieved from the storage module 910, the processing module 920 determines errors in communications between the controlling device and the network devices and reports the communications errors to, for example, an EMS or a user interface communicatively coupled to the communication interface module 900.

By virtue of the methods, system, devices, and sequences of instructions of the example embodiments of the invention described herein, a technician or a network management system can more easily isolate network errors caused by unsupported error messages. Furthermore, potential communication errors can be identified before deploying the network device in the field. By identifying potential communication errors, manufacturers can redesign their network devices so that communication errors can be reduced or minimized when these network devices are deployed in the field.

In the foregoing description, specific example embodiments of the invention are described. Although described in the context of ONTs, ONUs, and OLTs, in other embodiments, the described methods can be performed by RTs, NTs, or any other types of network devices. The specification and drawings are accordingly to be regarded in an illustrative rather than in a restrictive sense. It will, however, be evident that various modifications and changes may be made thereto, in a computer program product or software, hardware, or any combination thereof, without departing from the broader spirit and scope of the example embodiments of the invention described herein.

Example software embodiments of the invention may be provided as a computer program product, or software, that may include an article of manufacture on a machine-accessible or machine-readable medium (memory) having instructions. The instructions on the machine-accessible or machine-readable medium may be used to program a computer system or other electronic device. The machine-readable medium may include, but is not limited to, floppy diskettes, optical disks, CD-ROMs, and magneto-optical disks or other types of media/machine-readable media suitable for storing or transmitting electronic instructions. The techniques described herein are not limited to any particular software configuration. They may find applicability in any computing or processing environment. The terms “machine-accessible medium” or “machine-readable medium” used herein shall include any medium that is capable of storing, encoding, or transmitting a sequence of instructions for execution by the machine and that cause the machine to perform any one of the methods described herein. Furthermore, it is common in the art to speak of software, in one form or another (e.g., program, procedure, process, application, module, unit, logic, and so on) as taking an action or causing a result. Such expressions are merely a shorthand way of stating that the execution of the software by a processing system causes the processor to perform an action to produce a result. In other example embodiments, functions performed by software can instead be performed by hardcoded modules, and thus example embodiments of the invention are not limited only for use with stored software programs.

In addition, it should be understood that the figures illustrated in the attached drawings, which highlight the functionality and advantages of the example embodiments of the invention described herein, are presented for example purposes only. The architecture of the example embodiments of the invention described herein is sufficiently flexible and configurable, such that it may be utilized (and navigated) in ways other than that shown in the accompanying figures.

Although example aspects of the invention has been described in certain specific example embodiments, many additional modifications and variations would be apparent to those skilled in the art. It is therefore to be understood that the example embodiments of the invention described herein may be practiced otherwise than as specifically described. Thus, these example embodiments of the invention should be considered in all respects as illustrative and not restrictive.

What is claimed is:

1. A network device that provides at least one service, the network device comprising:
at least one communications interface adapted to communicate with at least one controlling device using a control protocol, wherein the at least one controlling device controls the network device to provide the at least one service;
a memory; and
a processor operable to, for each at least one controlling device, (i) receive a control message from the controlling device by way of the at least one communications interface, (ii) determine whether the control message is a supported message, (iii) generate error information if the control message is an unsupported control message, and (iv) store the error information in the memory.

2. The network device of claim 1, wherein the network device is one of an Optical Network Terminal (ONT) and an Optical Network Unit (ONU), and wherein the at least one controlling device is an Optical Line Terminal (OLT).

3. The network device of claim 1, wherein the control message includes at least a provisioning message for provisioning a service.

4. The network device of claim 1, wherein the control message includes an Optical Network Terminal (ONT) Management and Control Interface (OMCI) control message, the memory stores an OMCI Management Information Base (MIB), and the at least one controlling device includes an OMCI MIB.

5. The network device of claim 1, wherein the processor provides the error information to at least one of a controlling device and a test device by way of the at least one communications interface.

6. The network device of claim 1, wherein the unsupported control message is at least one of a control message having an unsupported format, a control message including at least one unsupported attribute, and a control message including at least one unsupported attribute value.

7. A controlling device that controls a network device that provides at least one service, the controlling device comprising:
at least one communications interface adapted to communicate with the network device using a control protocol;
a memory; and
a processor operable to (i) receive a notification message from the network device by way of the at least one communications interface, (ii) determine whether the notification message is a supported message, (iii) generate error information if the notification message is an unsupported notification message, and (iv) store the error information in the memory.

8. The controlling device of claim 7, wherein the network device is one of an Optical Network Terminal (ONT) and an Optical Network Unit (ONU), and wherein the controlling device is an Optical Line Terminal (OLT).

9. The controlling device of claim 7, wherein the notification message includes at least an alarm.

10. The controlling device of claim 7, wherein the notification message includes an Optical Network Terminal (ONT) Management and Control Interface (OMCI) notification message, the memory stores an OMCI Management Information Base (MIB), and the network device includes an OMCI MIB.

11. The controlling device of claim 7, wherein the processor provides the error information to at least one of an Element Management System (EMS) and a test device by way of the at least one communications interface.

12. The controlling device of claim 7, wherein the unsupported notification message is a notification message that includes an unknown alarm.

13. A system for providing at least one service, the system comprising:
the network device of claim 1; and
the at least one controlling device,
wherein each at least one controlling device includes:
at least one communications interface,
a memory, and
a processor operable to (i) receive a notification message from the network device by way of the at least one communications interface, (ii) determine whether the notification message is a supported message, (iii) generate error information if the notification message is an unsupported notification message, and (iv) store the error information in the memory of the controlling device.

14. The system of claim 13, wherein the controlling device generates and sends the control message to the network device, and the network device generates and sends the notification message to the controlling device.

15. A method for identifying communications errors in a communication system, the method comprising:
storing, in at least one network device, error information generated in response to an unsupported control message being received by the network device from at least one controlling device of the system;
retrieving the error information stored in the network device; and
identifying errors in communications between the network device and the controlling device, based on the error information retrieved.

16. The method of claim 15, further comprising:
storing, in the controlling device, error information generated in response to an unsupported notification message being received at the controlling device; and
retrieving the error information stored in the controlling device,
wherein the errors in communications are identified based on the error information retrieved from the controlling device and the error information retrieved from the network device.

17. The method of claim 16, wherein the system is a test system in a test environment operated by a testing service provider, and the method further comprises compensating the testing service provider operating the system.

18. The method of claim 17, wherein a manufacturer of the controlling device of the system requests the testing service provider to test the system, and the method further comprises the manufacturer compensating the testing service provider for operating the system.

19. The method of claim 17, wherein a manufacturer of the network device of the system requests the testing service provider to test the system, and the method further comprises the manufacturer compensating the testing service provider for operating the system.

20. The method of claim 17, wherein a service provider of a service provided by the system requests the testing service provider to test the system, and the method further comprises the service provider compensating the testing service provider for operating the system.

21. The method of claim 20, further comprising a manufacturer of the network device of the system compensating the service provider for requesting the testing service provider to test the system.

22. The method of claim 17, wherein the testing service provider manufactures the at least one controlling device of the system, and further comprising a manufacturer of the at least one network device of the system compensating the testing service provider by paying the testing service provider a royalty fee for each network device deployed in the system that communicates with the at least one controlling device deployed in the system and manufactured by the testing service provider.

23. A computer-readable medium having stored thereon sequences of instructions, the sequences of instructions including instructions which when executed by a computer system cause the computer system to perform a method for identifying communication errors in a communication system, the method comprising:
storing, in at least one network device, error information generated in response to an unsupported control message being received by the network device from at least one controlling device of the system;
storing, in the controlling device, error information generated in response to an unsupported notification message being received by the controlling device from the network device;
retrieving error information stored in the network device;
retrieving error information stored in the controlling device; and
identifying errors in communications between the network device and the controlling device, based on the error information retrieved from the network device and the error information retrieved from the controlling device.
